(19) United States
(12) Patent Application Publication
(10) Pub. No.: US 2009/0204834 A1
(43) Pub. Date: Aug. 13, 2009

(54) SYSTEM AND METHOD FOR USING INPUTS AS WAKE SIGNALS

(75) Inventors: Neil Hendin, Mountain View, CA (US); Ewa Kubalska, Los Gatos, CA (US); Zahid Najam, San Jose, CA (US); Stephane Le Provost, San Jose, CA (US); Brian Smith, Mountain View, CA (US)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA CORPORATION, Santa Clara, CA (US)

(21) Appl. No.: 12/029,346

(22) Filed: Feb. 11, 2008

(51) Int. Cl. G06F 1/32

(52) U.S. Cl. 713/323

(57) ABSTRACT

A system and method for waking up a portion of a programmable system on a chip (SoC). The system includes a power management unit for controlling power levels to the SoC and one or more inputs for receiving inputs from a coupled device. The system further includes a power management interface coupled to the one or more inputs. The power management interface signals the power management unit to adjust power levels to the SoC in response to receiving a signal via the one or more inputs corresponding to a wake event.

### FIELD OF THE INVENTION

Embodiments of the present invention are generally related to power management.

### BACKGROUND OF THE INVENTION

As technology has become more sophisticated, power requirements have correspondingly increased. Power management has thus become increasingly important, particularly in portable devices such as cellular phones and portable audio/video players in order for the device to have practical use. As a result technology devices are often put in to sleep or low power states to conserve power and thus extend battery life.

One such solution has been to have an external chip with external traces leading to the external chip which takes various wake events or signals to trigger an exit from a low power mode by sending one signal to a power supply to increase the power provided to activate currently inactive sections of the circuit. Unfortunately, the external chip and external traces use valuable circuit board space. Further, the external traces expose the wake signals to an electrical environment prone to interference. Further, the external traces load the inputs and decrease the operating frequency of these signals.

Additionally, pins on a microchip are expensive and thus having extra pins for wake events increases the cost of the integrated circuit. Moreover, dedicating pins to wake signals reduces the number of available pins for microchip functionality.

### SUMMARY OF THE INVENTION

Embodiments of the present invention provide a solution for receiving wake signals via inputs. Embodiments of the present invention receive wake signals without using external chips or devices or requiring extra dedicated pins.

In one embodiment, the present invention is implemented as a system for waking up a portion of a programmable system on a chip (SoC) or other integrated circuit. The system includes a power management unit for controlling power levels to the SoC and one or more inputs (e.g., device buttons) for receiving inputs from a coupled device. The system further includes an on-chip power management interface coupled to the one or more inputs. The power management interface signals the power management unit to adjust power levels to the SoC in response to receiving a signal via the one or more inputs corresponding to a wake event. The SoC may then be woken once the power levels are adjusted and operations prior to the sleep state may resume. The input pins on the SoC are coupled to the on-chip power management interface using a powered ring that may surround the SoC, in one embodiment. In this fashion the pins that are used to input signals to the SoC are the same pins that are used to recognize the wake event.

In another embodiment, the present invention is implemented as a method for waking a portion of a system on a chip (SoC). The method includes receiving a signal via an device input connector (e.g., a pin of a SoC) and determining whether the signal is a wake event (e.g., a lid flip, an SD card insertion, or a button press). Whether a signal constitutes a wake signal may be dynamically programmed (e.g., level signal and pulse width). In response to a wake event, a power management device may be signaled to adjust power levels to a portion of the SoC. A portion of the SoC corresponding to the wake event may then be signaled to wake up. The portion of the SoC woken may then resume operations that were suspended prior to entering the sleep state.

In this manner, embodiments of the present invention implement a mechanism to wake up a portion of a system using the standard chip pins or inputs as wake signals. Thus, extra pins or additional chips are not required. Embodiments further reduce leakage and facilitate low power or sleep states for a system on a chip without a change in performance or impact to the user experience.

In another embodiment, the present invention is implemented as a programmable system on a chip (SoC). The SoC includes a core including a plurality of functional units, a portion of which can be powered independently of each other. The SoC further includes a plurality of programmable connectors, a portion of which can operate as inputs and a power management interface for receiving wake events via the plurality of connectors. The power management interface invokes changes in power to portions of the SoC via a power supply unit. The SoC includes a powered ring to connect input pins to an on-chip power management interface that can detect a wake event. The on-chip power management interface may communicate to an off-chip power management unit which implements a wake function including waking the SoC.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary system architecture in accordance with one embodiment of the present invention.

FIG. 2 shows a block diagram of an exemplary system in accordance with one embodiment of the present invention.

FIG. 3 shows a block diagram of an exemplary component coupling in accordance with one embodiment of the present invention.

FIG. 4 shows an exemplary programmable system on a chip in accordance with one embodiment of the present invention.

FIG. 5 shows a flowchart of a process for waking a portion of a system on a chip in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

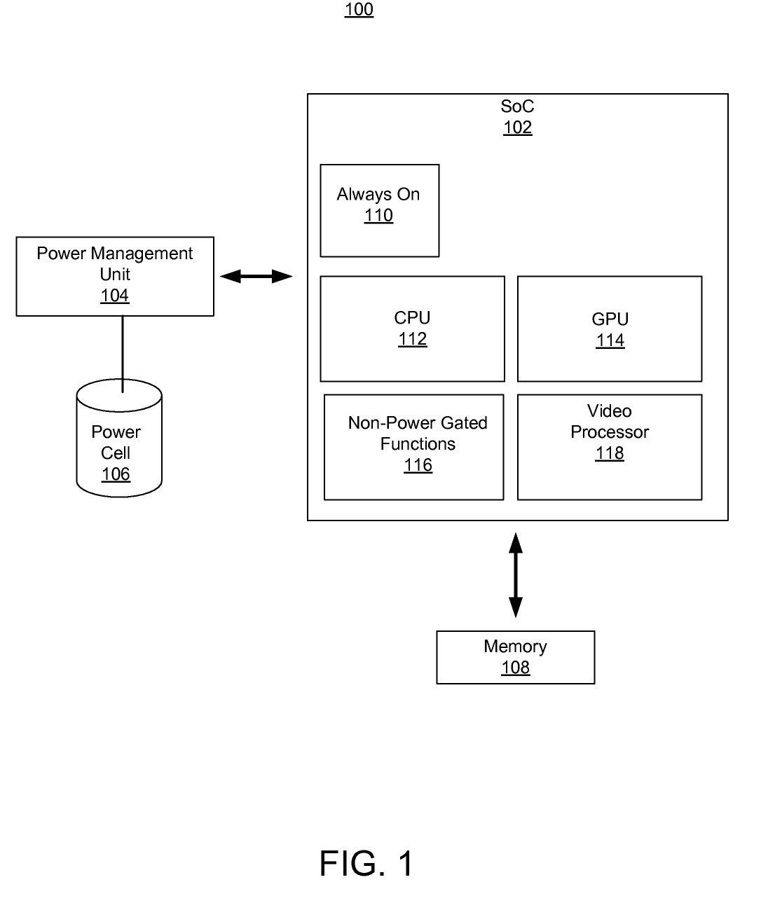

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### System Architecture:

FIG. 1 shows an exemplary system architecture in accordance with one embodiment of the present invention. System architecture 100 includes system on a chip (SoC) 102, external power management unit (PMU) 104, power cell 106, and memory 108. SoC 102 includes Always On module 110, central processor unit (CPU) 112, graphics processing unit (GPU) 114, non-power gated functions 116, and video processor 118.

System architecture 100 depicts the components of a basic system in accordance with embodiments of the present invention providing the execution platform for certain hardware-based and software-based functionality. Video processor 118 performs a variety of video related functions including, but not limited to, encoding, decoding, and re-encoding of video. Non-power gated functions 116 may be put into a sleep state but also remain powered while other portions of SoC 102 are put into a sleep state. Non-power gated functions 116 can provide functionality to facilitate real time responsiveness of a device.

The CPU 112 can access memory 108 via a bridge component/memory controller (not shown) or can be directly coupled to the memory 108 via a memory controller (not shown) internal to the CPU 112. Memory 108 facilitates storage of component (e.g., context information), application, and operating system information for SoC 102. For example, memory 108 may be used to store context information and other information when portions of SoC 102 enter low power or sleep states.

Power cell 106 provides power to system architecture 100. Power cell 106 may be a variety of power sources including, but not limited to, batteries, electrical sockets, and the like.

PMU 104 provides and regulates power to SoC 102. In one embodiment, PMU 104, provides power to SoC 102 via voltage rails (not shown) coupled to select group of components. For example, PMU 104 may provide power to Always on module 110 via an always on voltage rail and provide power to the rest of SoC 102 via a main voltage rail.

In one embodiment, always on module 110 is a power partition which remains powered while other portions of SoC 102 are put into a sleep state where their power is gated or disabled. Always on module 110 may thus facilitate portions of SoC 102 (e.g., CPU 112, GPU 114, video processor 118, and non-powered gated functions 116) entering and leaving sleep states. Always-on module 110 may include resources (e.g., registers and the like) for storing information to facilitate portions of SoC 102 going into a sleep state and quickly recovering their state after waking from a sleep state.

System architecture 100 can be implemented as, for example, a portable device or hand held device including, but not limited to, cellular telephone, personal digital assistant (PDA), smartphone, audio player (e.g., MP3 player), video player, and the like. In such an embodiment, components can be included that add peripheral buses, specialized audio/video components, IO devices, and the like.

Embodiments of the present invention implement a way to wake up a portion of a system (e.g., waking CPU 112 but leaving video processor 118 in a sleep mode) using the chip's standard pins and inputs (e.g., lid flip, button press, or input data) as wake signals. Thus, extra pins or additional chips are not required to detect a wake event. Embodiments further reduce leakage and facilitate low power or sleep states for a system on a chip without a change in performance (e.g., of CPU 112 or GPU 114, etc.) or impact to the user experience.

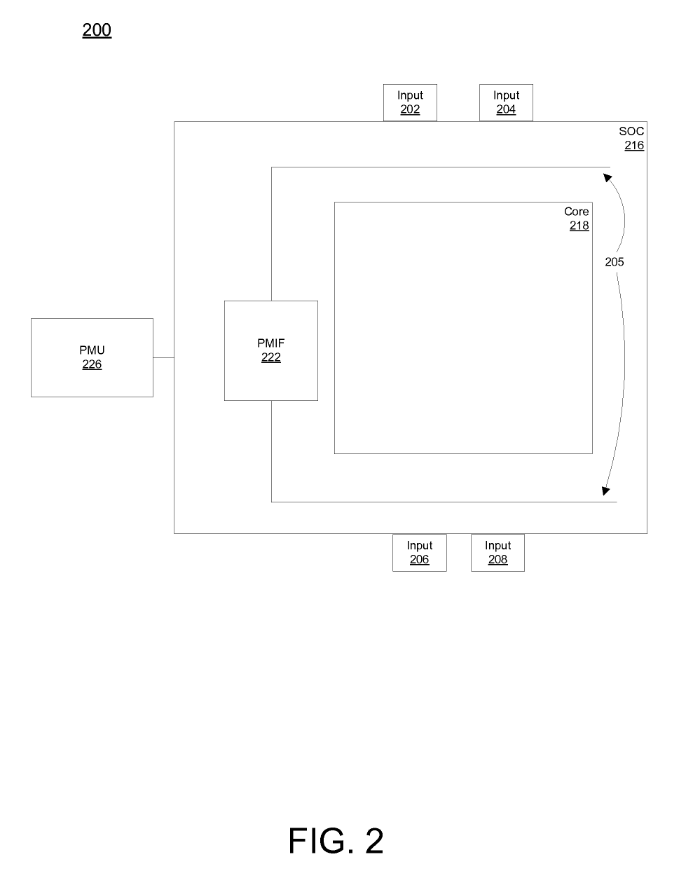

FIG. 2 shows a block diagram of an exemplary system 200 in accordance with one embodiment of the present invention. System 200 may include a programmable system on a chip (SoC) 216 (e.g., SoC 102) which wakes up or comes out of a sleep state based on a signal received via an input. SoC 216 may provide the functionality for a variety of devices, including, but not limited to, handheld devices, cellular telephones, personal digital assistants (PDAs), video playback devices, and audio playback devices. In one embodiment, SoC 216 includes core 218 and an on-chip power management interface (PMIF) 222, and SoC 216 is coupled to power management unit (PMU) 226.

SoC 216 may be coupled to one or more inputs 202-208 (e.g., pins or input pads, etc.) for receiving inputs from a device user, peripherals, or other devices (e.g., keypads, camera buttons, audio/video player buttons, and the like). It is appreciated that SoC 216 may be coupled to a variety of inputs including, but not limited to, removable storage slots (e.g., SD card slot), flip indicator, picture button, data inputs, camera buttons, navigation buttons, flash indicators, volume controls, and application associated buttons, WLAN interfaces, Bluetooth interfaces, and cellular network interfaces. It is appreciated that SoC 216 may be coupled to any number of inputs, a single input, or a multiplexer coupled to multiple inputs.

As described herein SOC 216 may have portions coupled to an always on power rail and other portions coupled to a main power rail or a set of power rails. The always on power rail allows substantial portions of SOC 216 to enter a sleep state while still powering a minimal portion (e.g., always on module 110) of SOC 216, in order to allow SOC 216 to be responsive to inputs and exit sleep mode in time to be responsive to inputs. For example, core 218 may include CPU 112, GPU 114, Video Processor 118 and non-power gated functions 116 which may be put into a sleep mode but be woken via a PMIF 222 (e.g., part of always on module 110). The use of an always on portion of SOC 216 allows efficient power usage and allows the use of a low frequency clock to further save power as it is recognized that a lower frequency clock causes an SOC or other microprocessor circuit to draw less power than a higher frequency clock. It is appreciated that PMIF 222 may wake up PMU 226 from a low power state before PMU 226 adjusts power to SoC 206.

Core 218 may be a processor or comprise various components for carrying out or performing various tasks (e.g., video processor, 3D graphics processing engine, central processing unit (CPU)). Core 218 or portions thereof may go into independent sleep states and upon waking up, resume operating under normal conditions. For example, a signal which would normally be handled via interrupt can be handled as a normal task as if core 218 or a portion thereof did not enter and awake from a sleep state. Thus, portions of core 218 may be powered independently.

PMU 226 controls and regulates power levels to SoC 216. PMU 226 may be an external circuit or part of SoC 216. For example, PMU 226 may provide power to SoC 216 via an main rail (e.g., coupled to Core 218) and an “always on” rail (e.g., coupled to PMIF) which remains powered when portions of SoC 216 are in a sleep state. It is appreciated that the PMU could be part of SoC 216 and be part of the always on portion of SoC 216. PMU 226 may further go into a low power state when the device is in an “off” mode which allows PMU 226 to wake from a sleep state on detection of the press of an “on” button.

Power management interface (PMIF) 222 signals PMU 226 to adjust the power levels provided to SoC 216. PMIF 222 may be coupled to one or more of inputs 202-208 and PMU 226 using a powered ring 205 to provide the coupling. The powered ring 205 may be part of the always on partition of the SoC 216. PMIF 222 may reside in SoC 216 (e.g., on the same integrated circuit die). PMIF 222 may signal PMU 226 in response to receiving a signal corresponding to a wake event via inputs coupled to SoC 216. For example, a user may press a camera button which is received by SoC 216 via an input (e.g., input 202) and in response PMIF 222 may signal PMU 226 to adjust power to the portion of SoC 216 which corresponds to camera functionality. PMIF 222 may then signal the camera functionality portion of SoC 216 to up wake up. Signals received over inputs 202-208 are wake events for the PMIF, such as data being received or other indicators of use activity. PMIF 222 may further include storage for storing events to detect if more than one wake event became valid during the wake up process. Such information may then be used by PMIF 222 to take different actions during the wake up process depending on which valid wake events were received.

PMIF 222 may include logic to recognize (e.g., via a mask) an input signal as a wake event. For example, a press of a talk key may not constitute a wake event while the press of a camera key to use the device as a camera may be a wake event and thereby require waking a portion of core 218. In one exemplary embodiment, with a small number of wake events and slow transition speeds, the signals from inputs 202-208 can be routed to PMIF 222 and logic to recognize/mask different types of events can be grouped in a common block or a combination of distributed and centralized logic can be used. The PMIF 222 can be programmed to recognize low to high transitions, high to low transitions, and level high or level low as trigger events independently for each input pin. PMIF 222 can also be programmed to recognize the level of signal and pulse width which can be used to determine whether a signal constitutes a wake event. Furthermore it is conceived that this logic may be implemented in such a method as to be reprogrammed, such that what constitutes a wake event may be different in different circumstances.

In one exemplary embodiment, a display controller and audio controller (not shown) may be part of a portion of SoC 216 which remains powered during a sleep state. This allows maximizing the use of low power states because portions of SoC 216 can be put into a low power state while a user listens to music, watches video, or a clock is displayed.

Once the PMIF 222 determines a wake signal, it may signal the wake event to the PMU 226 to commence a return of the SOC to a wake state.

Thus, system 200 facilitates portions of SoC 216 entering a sleep state and waking up and resuming operations without an impact to operations from a user's or peripheral's perspective. The ability to go into a sleep state even for a short time can be beneficial because such small savings of power can accumulate thereby increasing battery life.

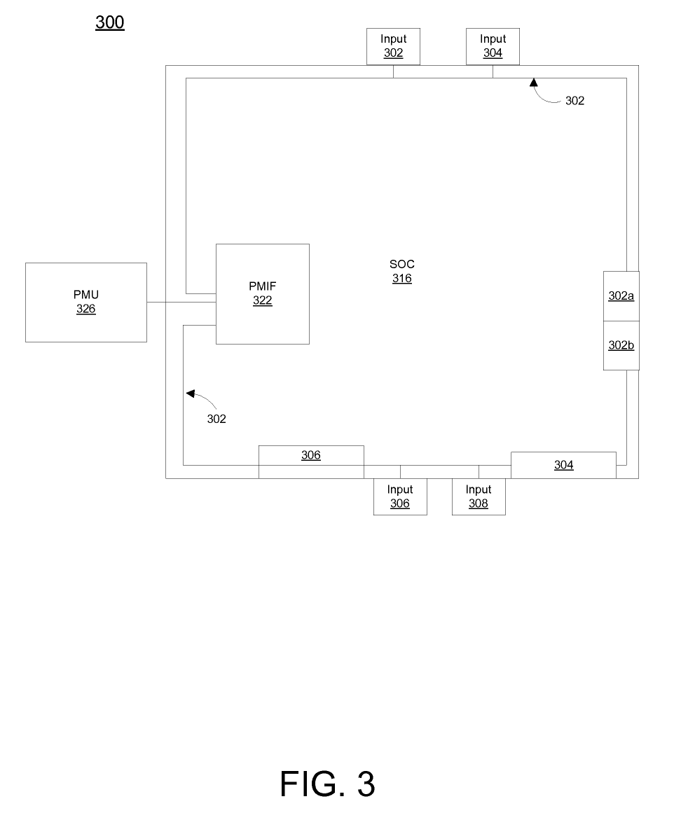

FIG. 3 shows a block diagram of an exemplary component coupling in accordance with one embodiment of the present invention. Inputs may be coupled to PMIF 322 via routing path 302 which includes multiple wires corresponding to each input. In one embodiment, routing path 302 may be a thin voltage rail on SoC 316 proximate to the edges or periphery of SoC 316. The thinness of routing path 302 allows power to be saved as leakage is minimized by minimizing the number of transistors than remain powered during sleep. Routing path 302 may further reside in a portion of SoC 316 that remains powered on while portions of SoC 316 are put into a sleep state.

Routing path 302 may route around or be rerouted over or under portions of SoC 316 which can be put into a sleep state (or in separate power partitions) independent of PMIF 322 such as areas 302a and 302b. Routing path 302 may also arc over areas such as area 304. Additionally, routing path 302 may be routed through an area of a component of SoC 316 such as area 306. Buffers may be coupled to routing path 302 to ensure signal integrity as the signal bypasses portions of SoC 316 (e.g., 302a, 302b, 304, and 306). The routing of wake signals by routing path 302 allows certain components and areas to be selectively powered and put into sleep states and thus saving power. It is appreciated that signals can be routed through SOC 316 to minimize the routing path along with sufficient buffering powered while portions of SOC 316 are powered down.

Advantageously, routing path 302 facilitates faster routing of signals because routing path 302 is part of SoC 316 and the substrate of SoC 316 provides a better electrical environment than external routing of signals. Routing path 302 facilitates the various input pins of SoC 316 to be coupled to PMIF 322 and thus used as wake signals.

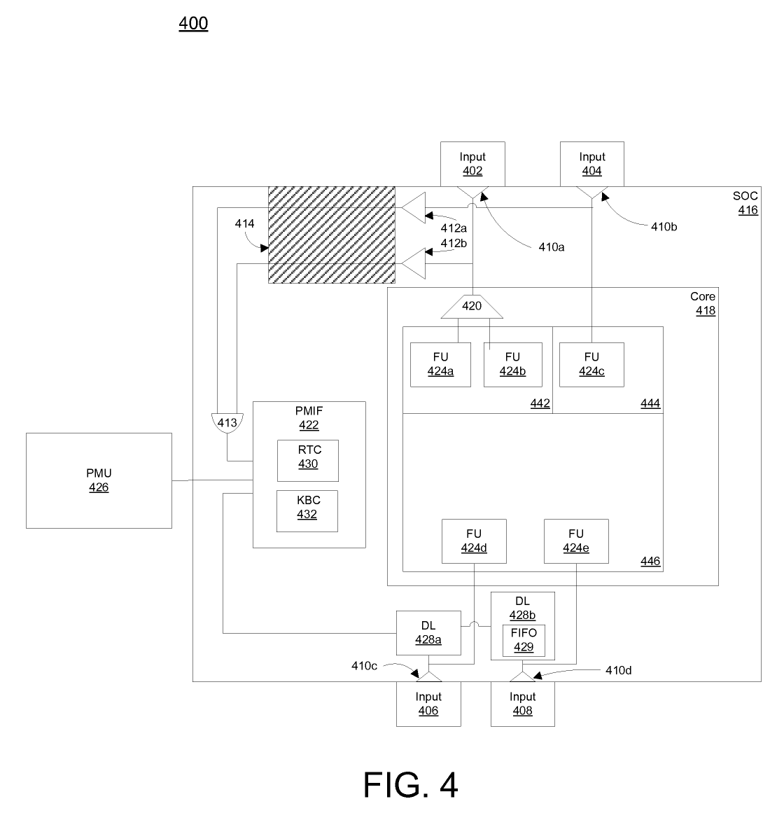

FIG. 4 shows an exemplary programmable system on a chip (SoC) in accordance with one embodiment of the present invention. SoC 416 is coupled to PMU 426 and inputs 402-408. SoC 416 may be coupled to inputs 402-408 via pins connecting SoC 416 to a circuit board. SoC 416 may further be coupled to inputs 402-408 via buffers 410a-d to ensure signal integrity.

Connections to inputs may be routed around SoC 416 to PMIF 422. The routing does not need to be continuous (e.g., routing path 302). For example, there may be discontinuous islands which are kept at an independent power partition such as area 414. Buffers 412a and 412b may be used to ensure signal quality is maintained in passing over the area 414 or discrete gate island 414 could be explicitly powered by a separate rail that will remain powered when a power is gated/disabled to other logic in island 414.

Inputs 402-408 may be coupled to a variety of device inputs and facilitate SoC 416 providing a variety of functions as described herein. For example, removable storage slots (e.g., SD card slot), flip indicator, picture button, camera buttons, navigation buttons, flash indicators, volume controls, and application associated buttons. As another example, an input may be attached to a lid of a cellular phone or a portable computing system. Inputs 402-408 may further be coupled to a variety of data storage circuits, including but not limited to, a latch (e.g., flip flop), or a register.

In one embodiment, inputs 402, 404, 406, and 408 are programmable connectors wherein a portion of the inputs can operate as inputs or outputs. Inputs 402-408 of SoC 416 may be general purpose input/output (GPIO) connectors which allows input and output functionality to be changed dynamically to correspond to specific functions of SoC 416. For example, SoC 416 may be configured to operate as part of a cellular telephone or other portable device and be customized according to the manufacturer of the device. GPIOs further allow software to receive a signal such as high, low or drive a high or low signal.

GPIO pins can also be connected to an output. A latch or other storage circuit may be coupled to the GPIO to drive the output during a sleep state and thus hold the last value for waking the device. Maintaining the output while portions of SoC 416 are in a sleep state prevents having to re-initialize peripherals (e.g., connected via inputs 402-408) and SoC 416 waiting a full wake or initiation sequence of a peripheral.

The input signals can be ORed/ANDed (e.g., via AND 413) with other wake events from the inputs 402-408 along the routing path to provide a smaller number of wake signals to PMIF 422. PMIF 422 may further be coupled to logic or circuits for receiving input signals and data while corresponding portions of SoC 416 are woken up. Such a design can be effective when there are a large number of potential wake events or some wake events are high speed edge transitions.

Core 418 includes functional units 424a-e for carrying out or performing various functions of SoC 416 including, but not limited to, cellular phone functions, camera functions, data access (e.g., SD memory access), application execution, general computing tasks, and the like. Functional units 424a-e may can be powered independently and multiple functional units may be coupled to an input (e.g., via multiplexer 420).

It is appreciated that functional units 424a-e may reside in independent power islands of a power partition which can be selectively powered or put into a sleep mode and thereby conserve power. Functional units 424a and 424b resides in power island 442, functional unit 424c resides in power island 444, and functional units 424d and 424e reside in power island 446.

In one embodiment, power management interface (PMIF) 422 receives signals from inputs 402-408 via wiring (e.g., routing path 302) proximate to the edges of SoC 416. PMIF 422 may be coupled to buffers and inputs (e.g., inputs 402-408). PMIF 422 determines based on the signals received from inputs 402-408 whether a wake event has occurred. As described herein, the determination of a wake event may be based on a wake event mask of a register coupled to inputs 402-408 and a comparison against a high, low, or transition detection circuit. Upon determining a wake event has occurred, PMIF 422 may invoke changes in power to portions (e.g., select power islands) of core 418 via a power supply unit such as PMU 426. For example, a signal could go high on input 402 indicating a cell phone lid has been opened and PMIF 422 can signal core 418 to wake up a functional unit corresponding to phone functionality.

In one embodiment, the wake time for the SoC 416 may be much lower than the signal switching time for input signals such that core 418 or any of functional units 424a-e awake before the input signal from inputs 402-408 propagates to core 418.

In one embodiment, PMIF 422 includes real time clock 430 and keyboard controller (KBC) 432. KBC 432 or other components may be included within PMIF 422 due to numerous connections and wires that would have to be routed on SoC 416 to PMIF 422 and thus conserve substrate surface area. It is appreciated that KBC 432 could located outside of PMIF 422 or as another chip coupled to SoC 416. RTC 430 may be used to wake up at an arbitrary interrupt and allow PMIF 422 to process signals in real time.

PMIF 422 may be powered independent of core 418 and other portions of SoC 416. PMIF 422 may be part of a power partition (e.g., Always On 110). PMIF 422 can further be independent of PMU 426 based on PMIF 422 being configured with the inherent delay for PMU 426 to adjust power level. In another embodiment, PMU 426 can also signal PMIF 422 when the power has been adjusted. Once PMIF 426 knows the power has been adjusted, the portion of core to be woken can be signaled.

SoC 416 may further include distributed logic units 428a and 428b coupled to inputs (e.g., inputs 428a and 428b) and PMIF 422. Distributed logic units 428a and 428b may be part of the same power partition (e.g., Always On 110) as PMIF 422 and thus remain powered while other portions of SoC 416 are in a sleep state. Distributed logic units 428a and 428b can be programmed to initiate a wake signal to PMIF 422 based on a high signal, a low signal, or a transition seen on an input pin. For example, distributed logic unit 428a could set a bit (e.g., register, flip-flop, latch, and the like) indicating a high speed transition occurred. Thus, the wake signal from the distributed logic unit can then propagate around SoC 416 to PMIF 222 in a slow manner. In one embodiment, signals may propagate from one distributed logic unit to distributed logic unit and may be coupled via an OR or AND circuit to PMIF 222.

Distributed logic units may further include first in first out (FIFO) 429 or other buffers to store input data in high speed environments to account for system wake-up delay. FIFO buffer 429 can be used to store an event transition involving associated data. For example, a high speed camera may require a FIFO in order to start streaming a picture. The FIFO buffer can be sized according to the amount of data that could be received while a portion of core 418 is being woken up. For example, the FIFO buffer can be sized to received data during the wake time of core 418, re-initialization of core 418 (e.g., loading context from memory or booting from a ROM image), and the time for the core 418 process the FIFO to catch up to real time. Additionally, the expected delay of PMU 426 to adjust power levels can be used in determining an appropriate size of a FIFO buffer in a distributed logic unit. It is appreciated that such customization may reduce the amount of logic in the distributed logic and thereby save power by minimizing the amount of leakage. It is further appreciated that distributed logic may be scaled up to a full processing function to allow for more complex logic functions, including ones that might change as the device operates in different modes.

In one embodiment, a latch may be part of distributed logic to capture high or low speed signal transitions. The distributed logic unit thus can be used to store the previous value and software can check if there was a high speed transition. Alternatively, an input can trigger the set/reset of a flip flop to signal that a transition has occurred.

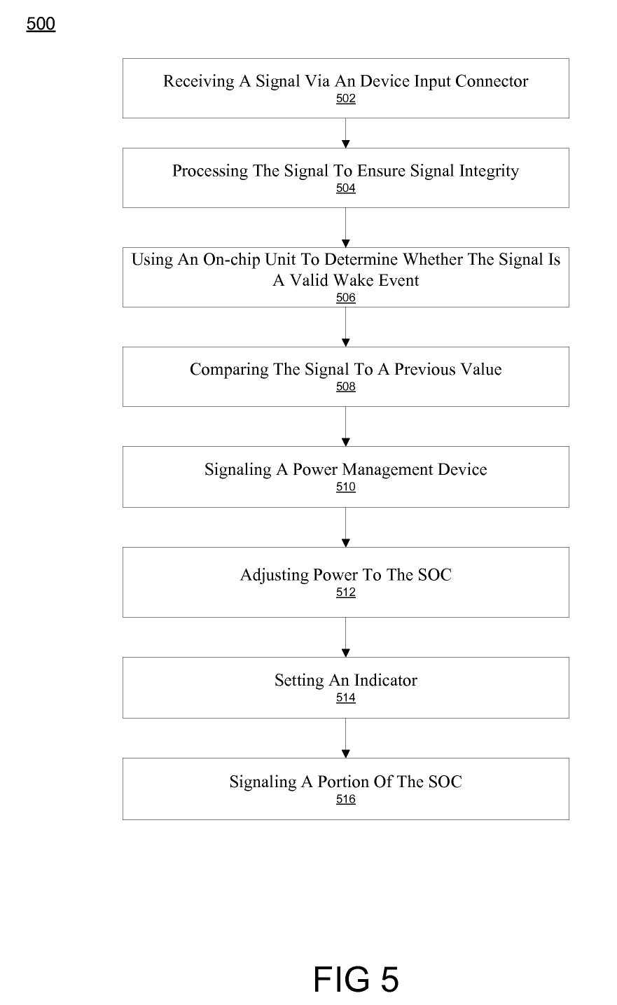

FIG. 5 shows a flowchart of the steps of a process 500 for waking a system on a chip in accordance with one embodiment of the present invention. It is appreciated that flowchart 500 may be carried out by a system on a chip (e.g., SoC 416 in conjunction with PMU 426).

At step 502, a signal is received via a device input connector. The device input connector may be a standard pin (e.g., not a dedicated wake function pin) on a SoC (e.g., SoC 216) and be coupled to a variety of devices as described herein (e.g., lid flip, keypad, camera buttons, and the like).

At step 504, the signal is processed to ensure signal integrity. As described herein, the signal may be amplified by a buffer (e.g., buffers 410a-d or 412a-b) or the signal can be debounced. The signal is routed using internal lines to an on-chip device for determining wake conditions. Routing can be via a thin always on power ring.

At step 506, whether the signal is a valid wake event is determined using the on-chip unit. As described herein a programmable mask of a register may be used to determine whether a signal constitutes a valid wake event of a given pin. For example, each of the inputs can be masked or ANDed with a mask bit so that only a selected group of input signals may correspond to wake events. In an exemplary embodiment, the mask may be a programmable control register for each of the values (e.g., wake on high, wake on low, ignore input, or wake on transition). The mask may further be a bit which is coupled to an AND gate and thereby compared to the input signal received with a value of 0, 1, or the previous value.

At step 508, the signal is compared to a previous value. As described herein, a previous value for an input may be stored (e.g., a latch, flip-flop, or register) and the signal can be compared to a transition (e.g., high speed transition). For example, to determine a transition the current signal of high may be compared to the previous value of low. Alternatively, the input can be used to set/reset a flop to flag a transition.

At step 510, a external power management device is signaled in response to the wake event as described herein in one embodiment. For example, the signaling of the power management device is via an interrupt. The power management device may be a power supply unit or PMU (e.g., PMU 226).

At step 512, the power management device adjusts power to the SoC. As described herein, the adjustment of power may turn on power to all or just portions of the SoC. For example, power to an HDMI video output may be left off while power is provided to the rest of the SoC.

At step 514, an indicator is set corresponding to whether the SoC should load information from memory or a boot image. The indicator may be a flag or a portion of a register. The boot image may be a read only memory (ROM), memory, flash device, etc. containing the operating system for the SoC or embedded software.

At step 516, a portion of the SoC corresponding to the wake event is signaled to wake up. The portion of SoC may load context information of the last task or tasks that the core (e.g., core 218) was performing prior to going into a sleep state. Based on the indicator set as described herein, context may be loaded from boot image or from memory.

Additionally, as described herein, after power is enabled and context restored, the input signals can propagate back to their normal functional blocks (e.g., blocks 424a-e) and operations continues transparent to the software and user.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for performing power management comprising:
a system on a chip integrated circuit;
one or more inputs to said system on a chip for receiving inputs from a coupled device;
a power management interface integrated on said system on a chip and coupled to said one or more inputs, wherein said power management interface signals said power management unit to adjust power levels to said system on a chip in response to receiving a signal via said one or more inputs corresponding to a wake event wherein said wake event is a signal received on said one or more inputs.

2. The system of claim 1 wherein said power management interface is coupled to said one or more inputs using a powered ring.

3. The system of claim 1 wherein said power manager interface comprises a real time clock (RTC).

4. The system of claim 1 wherein said power management interface comprises a keyboard controller (KBC).

5. The system of claim 1 wherein further comprising:
distributed logic coupled to at least one input and said power management interface for receiving data associated with an input signal.

6. The system of claim 5 wherein said distributed logic comprises first in first out (FIFO) buffer.

7. The system of claim 1 wherein at least one input is a general purpose input output (GPIO).

8. The system of claim 1 wherein at least one input is coupled to a latch and also coupled to said power management interface.

9. The system of claim 1 wherein at least one input is coupled to a buffer and coupled to said power management interface.

10. A method waking a portion of a system on an integrated circuit, comprising:
receiving a signal via an input pin of said integrated circuit;
using an on-chip device of said integrated circuit, determining whether said signal is a wake event;
in response to said wake event, signaling a power management device; and
signaling a portion of said integrated circuit corresponding to said wake event to exit sleep mode.

11. A method as described in claim 10 further comprising:
processing said signal to ensure signal integrity.

12. A method as described in claim 11 wherein said processing of said signal comprises debouncing said signal.

13. A method as described in claim 10 further comprising:
comparing said signal to a previous value.

14. A method as described in claim 10 wherein said signaling of said power management device is via an interrupt.

15. A method as described in claim 14 further comprising:
in response to said signaling of said power management device, said power management device adjusts power to said integrated circuit.

16. A method as described in claim 10 further comprising:
triggering a flag with the set/reset of a flip flop based on said signal.

17. A method as described in claim 10 wherein said signal is routed via an always on power ring.

18. A programmable system on a chip (SoC) comprising:
a core comprising a plurality of functional units wherein a portion of said functional units can be powered independently;
a plurality of input pins; and
a on-chip power management interface for receiving wake events via said plurality of input pins and wherein said power management interface invokes changes in power to portions of said core via an external power supply unit.

19. A SoC as described in claim 18 wherein said power management interface is coupled to said plurality of input pins via wires proximate to the edges of said SoC.

20. A SoC as described in claim 18 wherein said power management interface is powered independently of said core.
